(19) United States
(12) Patent Application Publication
(10) Pub. No.: US 2011/0213636 A1
(43) Pub. Date: Sep. 1, 2011

(54) TERMINAL, PROGRAM AND INVENTORY MANAGEMENT METHOD

(75) Inventor: Toshiyuki Sakuma, Kawasaki (JP)

(73) Assignee: HITACHI, LTD., Tokyo (JP)

(21) Appl. No.: 13/127,713

(22) PCT Filed: Nov. 4, 2009
(86) PCT No.: PCT/JP2009/068796

§ 371 Date: May 5, 2011

(30) Foreign Application Priority Data
Nov. 10, 2008 (JP) 2008-287942

(51) Int. Cl. G06Q 10/00

(52) U.S. Cl. 705/7.25

(57) ABSTRACT

Disclosed is a technique whereby demand for parts can be forecasted more accurately and parts inventory can be managed appropriately. A sensor information acquisition unit (123) acquires sensor information obtained from operating equipment (170). A sensor information analysis unit (124) detects abnormalities based on the acquired sensor information and specifies parts for which a malfunction is predicted. An operating equipment status classification unit (125) specifies parts for which a malfunction is predicted and parts for which no malfunction is predicted. A required parts quantity calculation unit (126) calculates the required quantity of parts as the inventory based on the number of parts for which a malfunction is predicted, the number of parts for which no malfunction is predicted, and the respective malfunction rates.

### TECHNICAL FIELD

The present invention relates to a technique for managing inventory of parts for use in operating equipment.

### BACKGROUND ART

Operating equipment such as an elevator and a rail facility is required to be provided with continuous preventive maintenance works, such as inspections, adjustment, and parts replacement. In addition, it is desired that on-site preventive maintenance works are completed in the minimum possible number of times and within a short period of time. Therefore, there is a tendency that such preventive maintenance works shift toward condition based maintenance rather than scheduled maintenance, and further, toward condition-based remote maintenance.

In the condition based maintenance, a part is replaced while monitoring the state of the operating equipment, thereby enabling the use of the part until it is worn out. Therefore, it is conceivable that frequency of parts replacement is decreased in the condition based maintenance, compared to the scheduled maintenance which replaces a part every predetermined period of time.

However, in the condition based maintenance, it is required to replace a part in the case where a result of inspection has determined that the replacement is necessary or in the case of failure occurrence, and thus it is difficult to purchase parts as scheduled. Consequently, there is no other choice but to preserve a generous amount of inventory for preventive maintenance to address such situations as described above. In other words, the parts replacement according to the condition based maintenance shows promise for reduction from the viewpoint of field operation cost, but it may be a serious problem from the viewpoint of inventory cost.

In this regard, for example, the patent document 1 discloses a technique to make a demand forecast which utilizes actual order performance, thereby achieving appropriate use of parts inventory for preventive maintenance.

### PRIOR ART DOCUMENT

### Patent Document

[Patent Document 1]
Japanese Unexamined Patent Application Publication No. 2007-293624

### SUMMARY OF THE INVENTION

### Problem to be Solved by the Invention

The technique described in the aforementioned patent document 1 forecasts a future demand based on past order performance, and it is an effective technique for a part that has a large number of actual order cases and shows a demand waveform undergoing a continuous and stable transition.

However, as the case of the parts for preventive maintenance, having a demand waveform being discrete and intermittent, the technique disclosed by the patent document 1 may be prone to generate a large prediction error, resulting in that there is no other choice but to preserve a generous amount of parts inventory so as to address the situation.

In view of the problem above, an object of the present invention is to provide a technique to make the parts demand forecasting more precisely, thereby enabling appropriate parts inventory management.

### Means to Solve the Problem

In order to solve the problem as described above, the present invention uses a sensor to monitor operating equipment, categorizes the operating equipment into a group as to which a failure is predicted, and a group as to which no failure is predicted, and calculates a required inventory quantity for each categorization.

For example, the present invention is directed to a terminal for managing parts inventory prepared for more than one unit of operating equipment, the terminal is provided with a storage section and a control section; the storage section storing failure-predicted pattern information including information for specifying; a failure-predicted pattern which is a pattern of a value obtained from a sensor monitoring a state of the operating equipment and indicates that a failure is predicted as to a part used in the operating equipment, the part having a possibility of failure occurrence when the failure-predicted pattern appears, and a first failure rate indicating a probability that the part fails to operate properly when the failure is predicted, and the storage section further storing operating equipment information including information for specifying; the operating equipment, the part used in the operating equipment, a quantity of the part used in the operating equipment, and a second failure rate indicating the probability that the part fails to operate properly when no failure is predicted, wherein, the control section performs; a process for specifying from the failure-predicted pattern information, a failure-predicted pattern which is associated with a pattern of the value, being determined as abnormal when obtained from the sensor which monitors the state of the operating equipment, a process for specifying the part having a possibility of malfunction as a failure-predicted part according to the failure-predicted pattern being specified, a process for specifying as a failure-predicted quantity from the operating equipment information, being a quantity of the failure-predicted part used in the operating equipment that has the value obtained from the sensor being determined as abnormal, a process for specifying as a no-failure-predicted quantity from the operating equipment information, being the quantity of the part of the same sort as the failure-predicted part, used in operating equipment other than the operating equipment that has the value obtained from the sensor being determined as abnormal, among at least one unit of the operating equipment, a process for calculating a first required quantity that is required as an inventory, when the part corresponding to the failure-predicted quantity fails to operate properly at the first failure rate, a process for calculating a second required quantity that is required as the inventory, when the part corresponding to the no-failure-predicted quantity fails to operate properly at the second failure rate, and a process for calculating a required inventory quantity of the part that is of the same sort as the failure-predicted part, by adding the first required quantity and the second required quantity.

### Effect of the Invention

As discussed above, according to the present invention, a demand forecast of a part is made more precisely, thereby achieving appropriate inventory management of the part.

### BRIEF DESCRIPTION OF DRAWINGS

FIG. 1 is a schematic diagram showing a parts inventory control system;

FIG. 2 is a schematic diagram showing an integrated center terminal;

FIG. 3 is a schematic diagram showing a failure-predicted pattern table;

FIG. 4 is a schematic diagram showing a failure prediction information table;

FIG. 5 is a schematic diagram showing an operating equipment information table;

FIG. 6 is a schematic diagram showing a management information table;

FIG. 7 is a schematic diagram showing a required parts quantity information table;

FIG. 8 is a schematic diagram showing a parts inventory information table;

FIG. 9 is a schematic diagram showing a parts replenishing information table;

FIG. 10 is a schematic diagram showing a computer;

FIG. 11 is a flowchart showing a process on the integrated center terminal;

FIG. 12 is a flowchart showing a process for collecting sensor information;

FIG. 13 is a flowchart showing a process for analyzing the sensor information;

FIG. 14 is a schematic diagram for explaining an abnormality diagnostic process;

FIG. 15 is a flowchart showing a process for categorizing the state of the operating equipment;

FIG. 16 is a flowchart showing a process for calculating the required parts quantity;

FIG. 17 is a flowchart showing a process for controlling the parts inventory; and

FIG. 18 schematically illustrates an inventory quantity in a local warehouse according to the parts inventory control system.

### BEST MODE FOR CARRYING OUT THE INVENTION

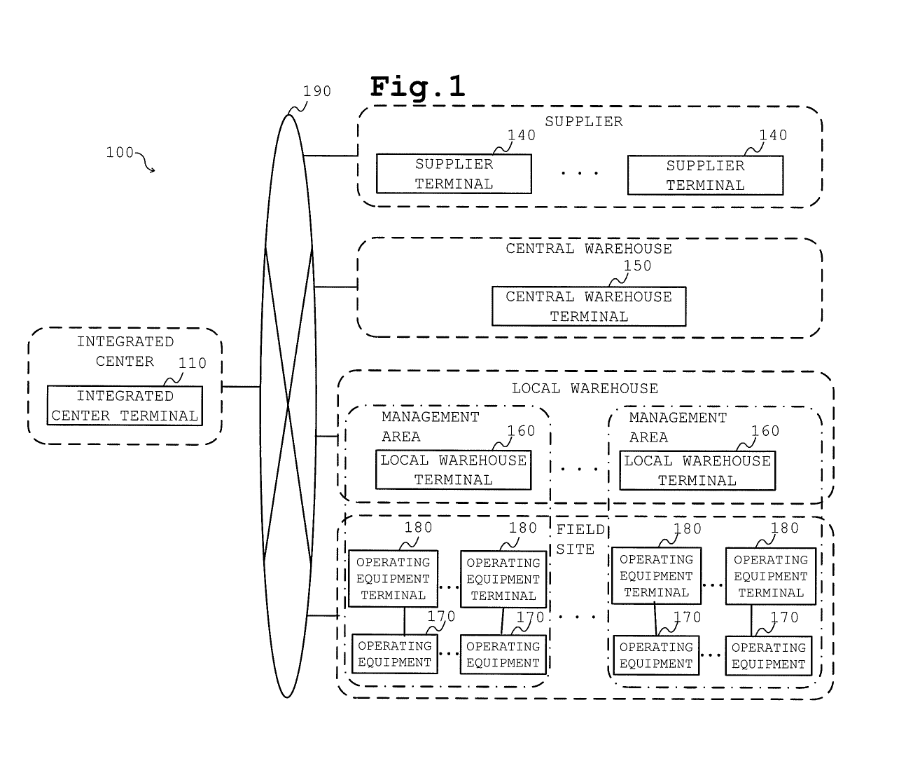

FIG. 1 is a schematic diagram showing the parts inventory control system 100 according to one embodiment of the present invention.

As illustrated, the parts inventory control system 100 incorporates an integrated center terminal 110 installed in an integrated center, a supplier terminal 140 installed in a supplier for supplying parts, a central warehouse terminal 150 installed in a central warehouse, a local warehouse terminal 160 installed in a local warehouse, operating equipment 170 as a target of management such as preventive maintenance, and an operating equipment terminal 180 for monitoring each operating equipment 170.

The operating equipment 170 and the operating equipment terminal 180 are placed at a site where the operating equipment 170 is installed, and a part to be mounted on the operating equipment 170 included in a predetermined management area is managed by a local warehouse terminal 160 placed in a local warehouse which is assigned to the management area.

Furthermore, the integrated center terminal 110, the supplier terminal 140, the central warehouse terminal 150, the local warehouse terminal 160, and the operating equipment terminal 180 are designed to send and receive information via a network 190.

In the parts inventory control system 100 as described above, the parts mounted on the operating equipment 170 are stockpiled in the local warehouse that is assigned to the management area including the operating equipment 170 (the local warehouse terminal 160 placed in the management area manages a quantity and the like of the parts being stockpiled), and when shortage occurs as to the parts stockpiled in the local warehouse, or the like, the central warehouse replenishes stocks (the central warehouse terminal 150 placed in the central warehouse manages the quantity of the parts or the like, stockpiled in the central warehouse). When shortage occurs as to the parts stockpiled in the central warehouse, or the like, an order is placed with a supplier for the parts (the supplier terminal 140 manages the order and delivery of the parts).

The integrated center terminal 110 controls the quantity of the parts stockpiled in each of the local warehouses, the quantity of the parts stockpiled in the central warehouse, and the quantity of the parts ordered with the supplier.

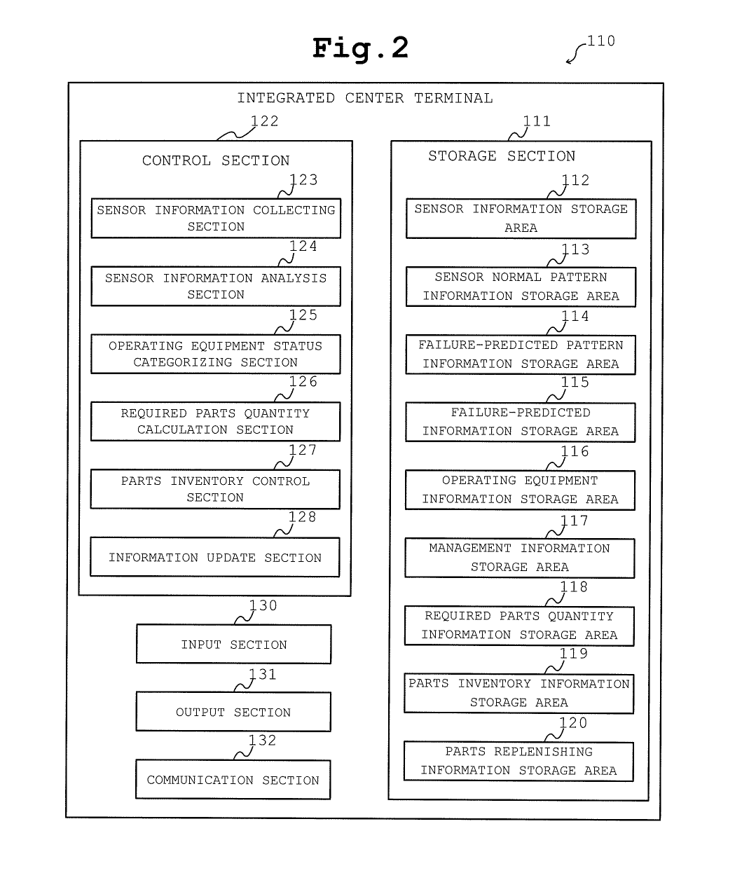

FIG. 2 is a schematic diagram showing the integrated center terminal 110.

As illustrated, the integrated center terminal 110 incorporates a storage section 111, a control section 122, an input section 130, an output section 131, and a communication section 132.

The storage section 111 incorporates a sensor information storage area 112, a sensor normal pattern information storage area 113, a failure-predicted pattern information storage area 114, a failure prediction information storage area 115, an operating equipment information storage area 116, a management information storage area 117, a required parts quantity information storage area 118, a parts inventory information storage area 119, and a parts replenishing information storage area 120.

The sensor information storage area 112 stores sensor information that is measured by a sensor installed in each of the operating equipment 170.

By way of example, in the present embodiment, the operating equipment terminal 180 stores sensor information including information for specifying a value that is measured by the sensor installed in each of the operating equipment 170, and information for specifying a time when the value is measured. Then, the integrated center terminal 110 acquires the sensor information from the operating equipment terminal 180, stores the sensor information in the sensor information storage area 112, in association with identification information for identifying the operating equipment 170 as to which the sensor information is acquired.

The sensor normal pattern information storage area 113 stores information for specifying a sensor normal pattern which determines that the value measured by the sensor installed in the operating equipment 170 is normal.

By way of example, in the present embodiment, an upper limit and a lower limit based on which the value measured by the sensor installed in the operating equipment 170 is determined to be normal, are stored in association with the time when the value is measured. However, the present embodiment is not limited to this example.

The failure-predicted pattern information storage area 114 stores information for specifying a failure-predicted pattern based on which it is possible to determine that the value measured by the sensor installed in the operating equipment 170 predicts failure.

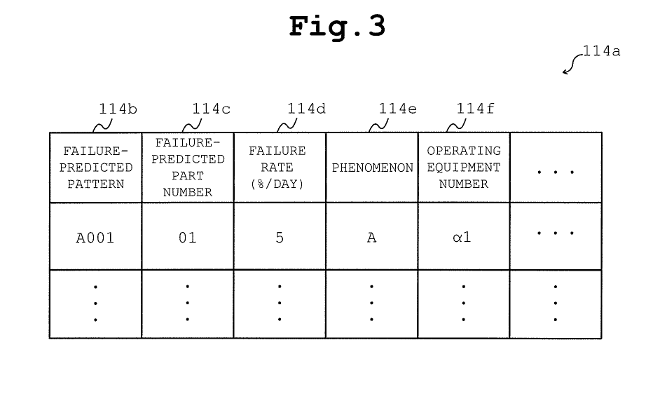

By way of example, in the present embodiment, a failure-predicted pattern table 114a as shown in FIG. 3 (a schematic diagram of the failure-predicted pattern table 114a) is stored in the failure-predicted pattern information storage area 114.

As illustrated, the failure-predicted pattern table 114a includes a failure-predicted pattern field 114b, a failure predicted part number field 114c, a failure rate field 114d, a phenomenon field 114e, and an operating equipment number field 114f.

The failure-predicted pattern field 114b stores information for specifying a failure-predicted pattern that is a pattern representing a time-series change of the value for determining that a failure is predicted, as to the value measured by the sensor installed in the operating equipment 170. It is to be noted here that in the present embodiment, a failure-predicted pattern number for identifying each failure-predicted pattern is assigned, and the failure-predicted pattern number is stored in the failure-predicted pattern field 114b.

The failure-predicted pattern information storage area 114 stores a failure-predicted pattern for specifying a time-series change of a value, in association with the failure-predicted pattern number.

The failure predicted part number field 114c stores information for specifying a part which has a possibility of malfunction, when the value measured by the sensor installed in the operating equipment 170 becomes to indicate the failure-predicted pattern that is specified in the failure-predicted pattern field 114b. In the present embodiment, a part number is assigned to each of the parts for unique identification, and the part number is stored in the failure predicted part number field 114c.

The failure rate field 114d stores information for specifying a failure rate being a rate of failure incidence, when the value measured by the sensor installed in the operating equipment 170 becomes to indicate the failure-predicted pattern specified by the failure-predicted pattern filed 114b.

The phenomenon field 114e stores information for specifying a description of the phenomenon which occurs when the value measured by the sensor installed in the operating equipment 170 becomes to indicate the failure-predicted pattern specified by the failure-predicted pattern filed 114b.

The operating equipment number field 114f stores information for specifying the operating equipment 170 mounting the part specified in the failure predicted part number field 114c. Here, in the present embodiment, an identification number, being a serial number starting from 1, is assigned to each of the operating equipment 170 for unique identification, and the operating equipment number field 114f stores the operating equipment number obtained by adding “α” indicating the operating equipment, to the identification number (α1, . . . αm: m is a natural number).

Referring to FIG. 2 again, the failure prediction information storage area 115 stores information for specifying a failure-predicted operating equipment 170 and the part thereof, when the value measured by the sensor installed in the operating equipment 170 indicates that a failure is predicted.

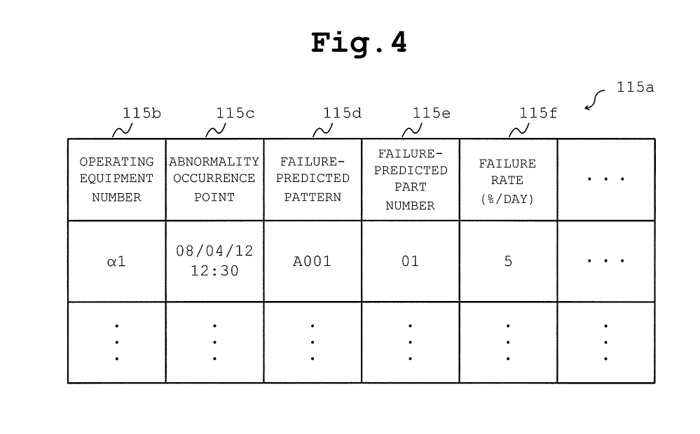

By way of example, in the present embodiment, a failure prediction information table 115a as shown in FIG. 4 (a schematic diagram of the failure prediction information table 115a) is stored in the failure prediction information storage area 115.

As illustrated, the failure prediction information table 115a has an operating equipment number field 115b, an abnormality occurrence point field 115c, a failure-predicted pattern field 115d, a failure predicted part number field 115e, and a failure rate field 115f.

The operating equipment number field 115b stores information (operating equipment number) for specifying the operating equipment as to which the value of the sensor corresponding to the failure-predicted pattern is acquired.

The abnormality occurrence point field 115c stores information for specifying a time point when the value of the sensor corresponding to the failure-predicted pattern is acquired. In the present embodiment, the abnormality occurrence point field 115c stores information for specifying a time point (the time when the value is measured, acquired from the sensor information which stores the value) when the value of the sensor corresponding to the failure-predicted pattern is firstly acquired.

The failure-predicted pattern field 115d stores identification information for identifying the failure-predicted pattern to which the value measured by the sensor installed in the operating equipment 170 corresponds.

The failure predicted part number field 115e stores identification information (here, apart number being assigned for unique identification of each part) for identifying the part having a possibility of malfunction, according to the failure-predicted pattern to which the value measured by the sensor installed in the operating equipment 170 corresponds.

The failure rate field 115f stores information for specifying the failure rate which denotes a probability of failure occurrence, when it is determined that the value measured by the sensor installed in the operating equipment 170 predicts a failure according to the failure-predicted pattern specified in the failure-predicted pattern field 115d.

Referring to FIG. 2 again, the operating equipment information storage area 116 stores information as to each of the operating equipment 170, and information relating to the parts incorporated in the operating equipment 170.

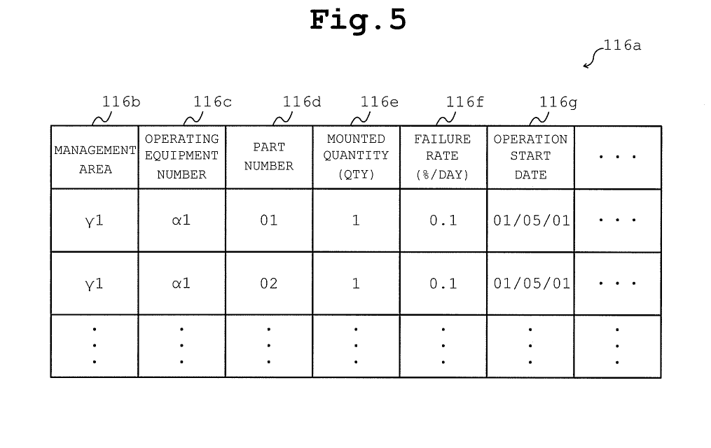

By way of example, in the present embodiment, the operating equipment information table 116a as shown in FIG. 5 (a schematic diagram of the operating equipment information table 116a) is stored in the operating equipment information storage area 116.

The operating equipment information table 116a includes a management area field 116b, an operating equipment number field 116c, a part number field 116d, a mounted quantity field 116e, a failure rate field 116f, and an operation start date field 116g.

The management area field 116b stores information for specifying the management area to which the operating equipment 170 belongs, the operating equipment being specified in the operating equipment number field 116c described below.

The operating equipment number field 116c stores the information that specifies the operating equipment (operating equipment number).

The part number field 116d stores information (here, the part number assigned for unique identification of each part) for specifying a part incorporated in the operating equipment 170 that is specified in the operating equipment number field 116c.

The mounted quantity field 116e stores information for specifying a quantity of parts which are mounted on the operating equipment 170 specified in the operating equipment number field 116c, the part being specified in the part number field 116d.

The failure rate field 116f specifies information for specifying a failure rate denoting the probability that the part specified in the part number field 116d fails to operate. It is to be noted that the failure rate field 116f stores a failure rate of the part that is not predicted to fail.

The operation start date field 116g stores information for specifying the date when the operating equipment 170 specified in the operating equipment number field 116c started operation.

Referring to FIG. 2 again, the management information storage area 117 stores information for specifying a threshold used to calculate a lead time for replenishing the part in the central warehouse or in the local warehouse, and a required parts quantity.

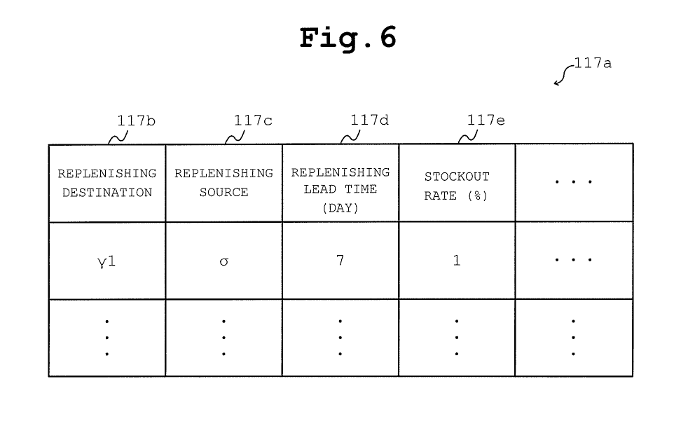

By way of example, in the present embodiment, the management information table 117a as shown in FIG. 6 (a schematic diagram of the management information table 117a) is stored in the management information storage area 117.

The management information table 117a includes a replenishing destination field 117b, a replenishing source field 117c, a replenishing lead time field 117d, and a stockout rate field 117e.

The replenishing destination field 117b stores information for specifying the central warehouse or a local warehouse in which parts are replenished.

The replenishing source field 117c stores information for specifying the central warehouse or a supplier serving as the replenishing source of the part.

The replenishing lead time field 117d stores information for specifying a replenishing lead time from placing an order of a part until delivering the part.

The stockout rate field 117e stores information for specifying a probability of stockout occurrence of the part. It is to be noted that if the stockout rate is set to be a smaller value, the number of parts accumulated against the failure occurrence has to be made larger. Therefore, it is required to store a practical value in the stockout rate field 117e, the value allowing a certain shortage of the part. The number obtained by getting rid of “%” from the stockout rate (e.g., stockout rate 1% is represented as “0.01”) denotes the probability of stockout.

Now, returning to FIG. 2, the required parts quantity information storage area 118 stores information for specifying a required parts quantity to be stocked in the local warehouse with respect to each management area.

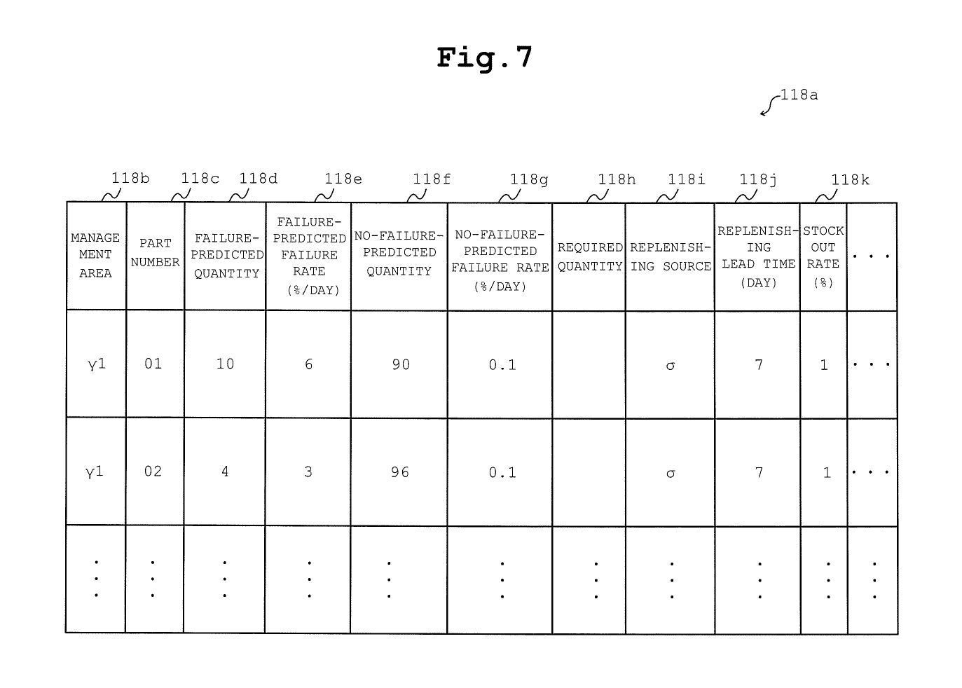

By way of example, in the present embodiment, the required parts quantity information table 118a as shown in FIG. 7 (a schematic diagram of the required parts quantity information table 118a) is stored in the required parts quantity information storage area 118.

The required parts quantity information table 118a includes, a management area field 118b, a part number field 118c, a failure-predicted quantity field 118d, a failure-predicted failure rate field 118e, a no-failure-predicted quantity field 118f, a no-failure-predicted failure rate field 118g, a required quantity field 118h, a replenishing source field 118i, a replenishing lead time field 118j, and a stockout rate field 118k.

The management area field 118b stores information for specifying a management area. Here, in the present embodiment, an identification number, being a serial number starting from 1, is assigned to each management area, and the management area field 118b stores a management area number obtained by adding “γ” representing the management area, to the identification number (γ1, . . . γn: n is a natural number).

The part number field 118c stores information (part number) for specifying a part that is mounted on the operating equipment 170 included in the management area specified by the management area field 118b.

The failure-predicted quantity field 118d stores information for specifying a quantity of failure-predicted parts, among the parts specified by the part number field 118c and mounted on the operating equipment 170 included in the management area specified by the management area field 118b.

The failure rate of failure-predicted part field 118e stores information for specifying a failure rate of the failure-predicted part, the part being specified by the part number field 118c.

The no-failure-predicted parts quantity field 118f stores information for specifying a quantity of no-failure-predicted parts, among the parts specified by the part number field 118c and mounted on the operating equipment 170 included in the management area specified by the management area field 118b.

The failure rate of no-failure-predicted part field 118g stores information for specifying a failure rate of the no-failure-predicted part, the part being specified by the part number field 118c.

The required quantity field 118h stores information for specifying a required quantity of the part necessary to be stocked in the management area, the part being specified in the part number field 118c and mounted on the operating equipment 170 included in the management area specified in the management area field 118b.

The replenishing source field 118i stores information for specifying a replenishing source from which the part specified by the part number field 118c is replenished.

The replenishing lead time field 118j stores information for specifying a lead time for receiving the replenishment of the part which is specified in the part number field 118c.

The stockout rate field 118k stores information for specifying a probability of stockout occurrence as to the part that is specified by the part number field 118c.

Referring to FIG. 2 again, the parts inventory information storage area 119 stores information for specifying parts inventory in the central warehouse and in each local warehouse.

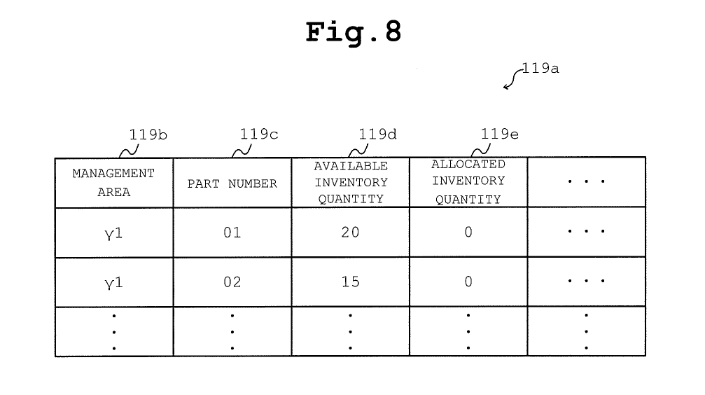

By way of example, in the present embodiment, the parts inventory information table 119a as shown in FIG. 8 (a schematic diagram of the parts inventory information table 119a) is stored in the parts inventory information storage area 119, for the central warehouse and for each local ware house.

The parts inventory information table 119a includes a management area field 119b, a part number field 119c, an available inventory quantity field 119d, and an allocated inventory quantity field 119e.

The management area field 119b stores information for specifying the management area including a target local warehouse as to which information is stored in the parts inventory information table 119a. Here, in the present embodiment, the central warehouse does not belong to any management area, and thus the management area field 119b of the parts inventory information table 119a for the central warehouse is made blank.

The part number field 119c stores information for specifying a part to be stocked in the central warehouse or in the local warehouse which is a target for storing information in the parts inventory information table 119a.

The available inventory quantity field 119d stores information for specifying a quantity of inventory of the part that is specified by the part number field 119c.

The allocated inventory quantity field stores information for specifying a quantity reserved to be allocated to other warehouse.

Referring to FIG. 2 again, the part replenishing information storage area 120 stores information for specifying matters relating to replenishment of the part, when replenishment of the parts is carried out in the central warehouse and in the local warehouse.

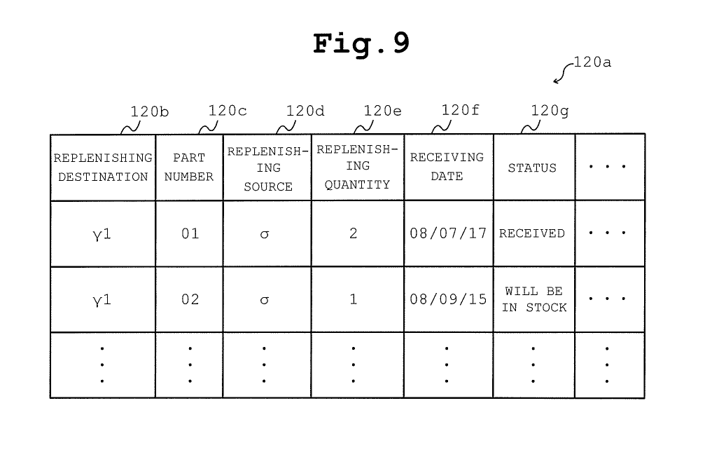

By way of example, in the present embodiment, the parts replenishing information table 120a as shown in FIG. 9 (a schematic diagram of the parts replenishing information table 120a) is stored.

The parts replenishing information table 120a includes a replenishing destination field 120b, apart number field 120c, a replenishing source field 120d, a replenishing quantity field 120e, a receiving date field 120f, and a status field 120g.

The replenishing destination field 120b stores information for specifying a replenishing destination of the part specified by the part number field 120c which will be described below.

The part number field 120c stores information for specifying a part to be replenished.

The replenishing source field 120d stores information for specifying a replenishing source which replenishes the part specified by the part number field 120c.

The replenishing quantity field 120e stores information for specifying a quantity of the parts to be replenished, the part being specified by the part number field 120c.

The receiving date field 120f stores information for specifying a date on which the part specified by the part number field 120c is received by the replenishing destination, the destination being specified by the replenishing destination field 120b.

The status field 120g stores information for specifying a replenishing status of the part that is specified by the part number field 120c. By way of example, if the part has already been received, a character string “RECEIVED” is stored, and if the part has not been received yet, a character string “WILL BE IN STOCK” is stored.

Referring to FIG. 2 again, the figure shows that the control section 122 includes a sensor information collecting section 123, a sensor information analysis section 124, an operating equipment status categorizing section 125, a required parts quantity calculating section 126, a parts inventory control section 127, and an information update section 128.

The sensor information collecting section 123 performs processing for collecting from the operating equipment terminal 180, sensor information obtained by the operating equipment 170, and storing the sensor information in the sensor information storage area 112, in association with the operating equipment 170 from which the sensor information is acquired.

The sensor information analysis section 124 performs processing for detecting abnormality from the sensor information stored in the sensor information storage area 112, and specifying a failure-predicted part.

The operating equipment status categorizing section 125 performs processing that determines by calculation, failure-predicted parts and no-failure-predicted parts, with respect to each management area.

The required parts quantity calculating section 126 performs processing for calculating a required quantity of the parts which are to be stocked in each of the management areas, according to the quantity of the failure-predicted parts, the quantity of the no-failure-predicted parts, and the failure rates for both quantities, respectively.

The parts inventory control section 127 performs processing for calculating a replenishing quantity from the central warehouse to the local warehouse, and an order quantity from the central warehouse to the supplier, so that the parts corresponding to the required parts quantity calculated in the required parts quantity calculating section 126 are stocked in the local warehouse.

The information update section 128 updates information stored in the storage section 111 of the integrated center terminal 110.

By way of example, the information update section 128 accepts via the input section 130, and the like, a change of the information stored in the parts inventory information table 119a, the failure-predicted pattern table 114a, and the operating equipment information table 116a. Then, the information update section 128 reads associated tables from the storage section 111, and updates the corresponding information. It is to be noted that inputting of information may be accepted via the network 190, from each of the operating equipment terminal 180, the local warehouse side terminal 160, the central warehouse terminal 150, the supplier terminal 140, and the like. Alternatively, inputs of information may be accepted in conjunction with occurrence of any change in those terminals.

The input section 130 accepts inputting of information.

The output section 131 outputs information.

The communication section 132 receives and sends information via the network 190.

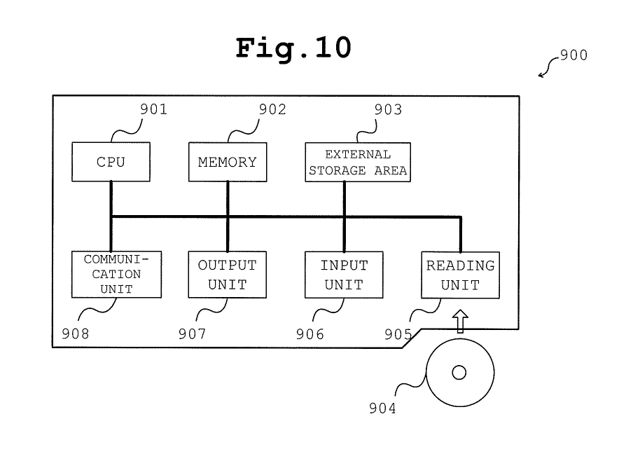

The integrated center terminal 110 as described above may be implemented by a general computer 900, for example as shown in FIG. 10 (a schematic diagram of the computer 900), incorporating a CPU (Central Processing Unit) 901, a memory 902, an external storage unit 903 such as an HDD (Hard Disk Drive), a reading unit 905 for reading and writing information from and on a storage medium 904 with portability such as CD-ROM (Compact Disk Read Only Memory) and DVD-ROM (Digital Versatile Disk Read Only Memory), an input unit 906 such as a keyboard and a mouse, an output unit 907 such as a display, and a communication unit 908 such as NIC (Network Interface Card) for establishing connection with the communication network.

By way of example, followings are possible; the CPU 901 utilizes the memory 902 or the external storage unit 903 to implement the storage section 111. The CPU 901 loads a predetermined program stored in the external storage unit 903 on the memory 902, and executes the program to implement the control section 122. The CPU 901 utilizes the input unit 906 to implement the input section 130, the CPU 901 utilizes the output unit 907 to implement the output section 131, and the CPU 901 utilizes the communication unit 908 to implement the communication section 132.

The predetermined program may be downloaded on the external storage unit 903, from the storage medium 904 via the reading unit 905 or from the network via the communication unit 908, and then it may be loaded on the memory 902 and executed by the CPU 901. Alternatively, the program may be downloaded from the storage medium 904 via the reading unit 905, or from the network via the communication unit 908, directly on the memory 902, and then it may be executed by the CPU 901.

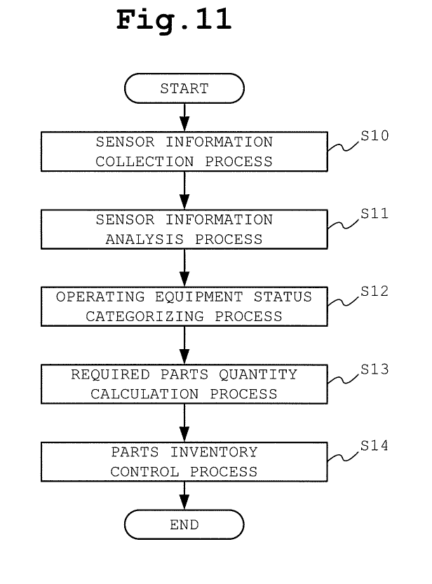

FIG. 11 is a flowchart showing the process on the integrated center terminal 110.

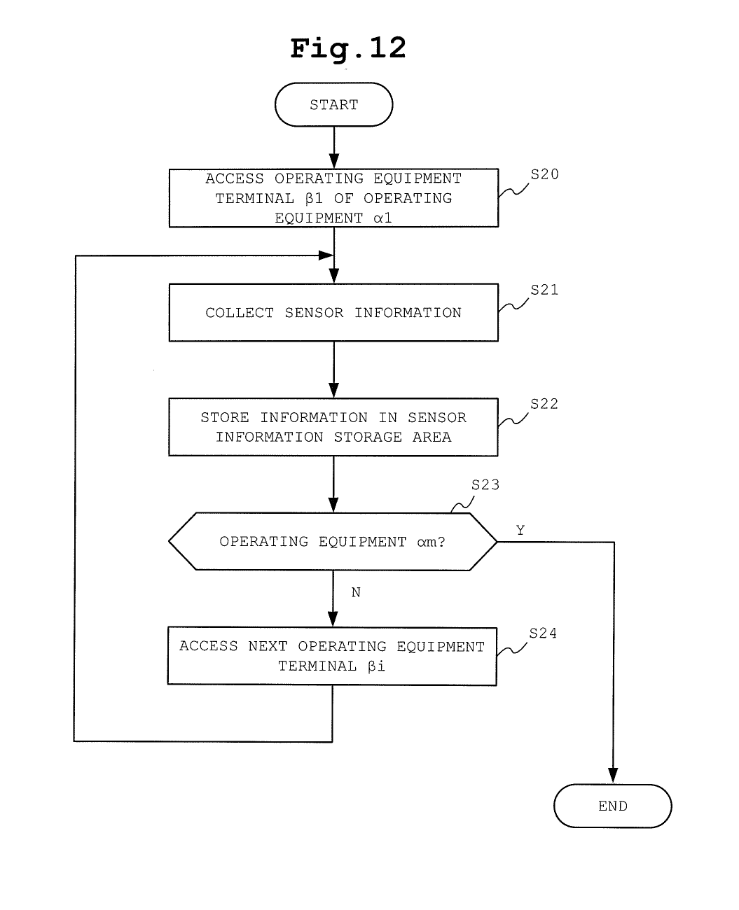

Firstly, the sensor information collecting section 123 of the integrated center terminal 110 performs processing for collecting from the operating equipment terminal 180, the sensor information obtained by the operating equipment 170 (S10). This process will be explained in detail with reference to FIG. 12.

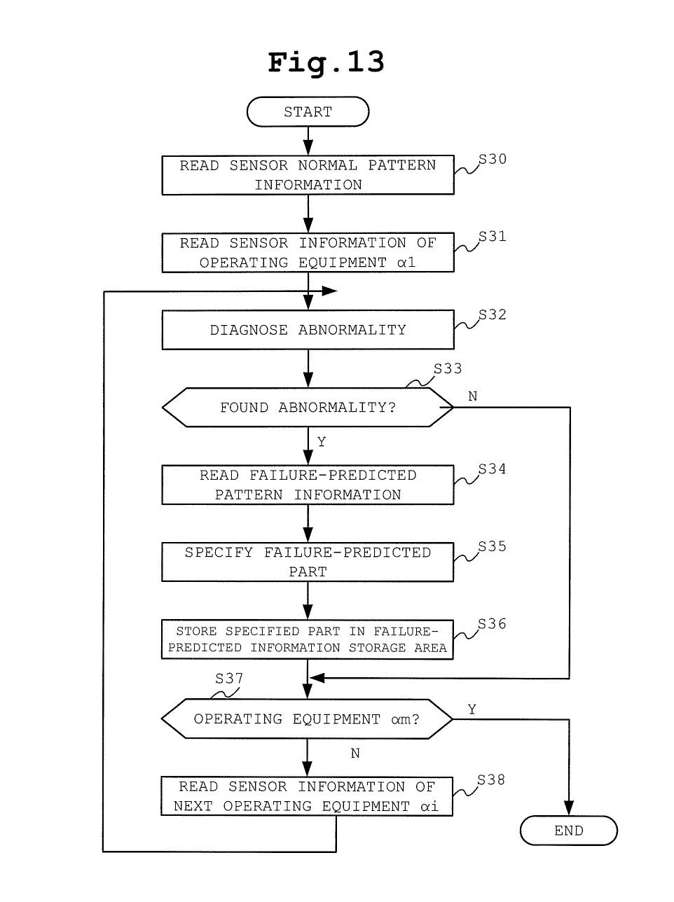

Next, the sensor information analysis section 124 detects abnormality from the sensor information collected in the step S10, and performs processing for specifying a failure-predicted part (S11). This process will be explained in detail with reference to FIG. 13.

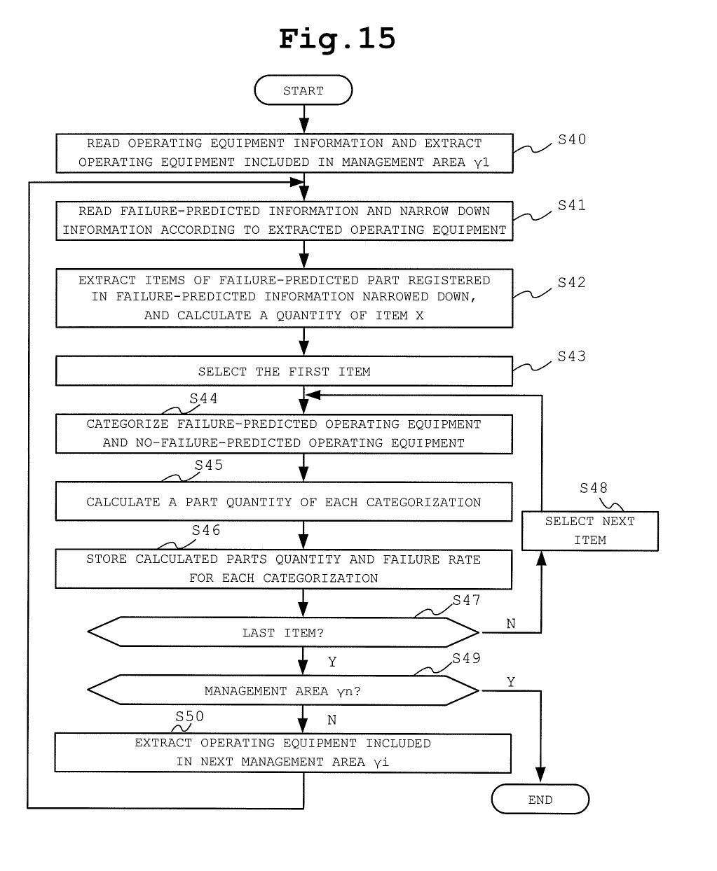

Next, the operating equipment status categorizing section 125 categorizes the parts into failure-predicted parts and no-failure-predicted parts, and performs processing for calculating a quantity of the parts belonging to each group, with respect to each management area (S12). This process will be explained in detail with reference to FIG. 15.

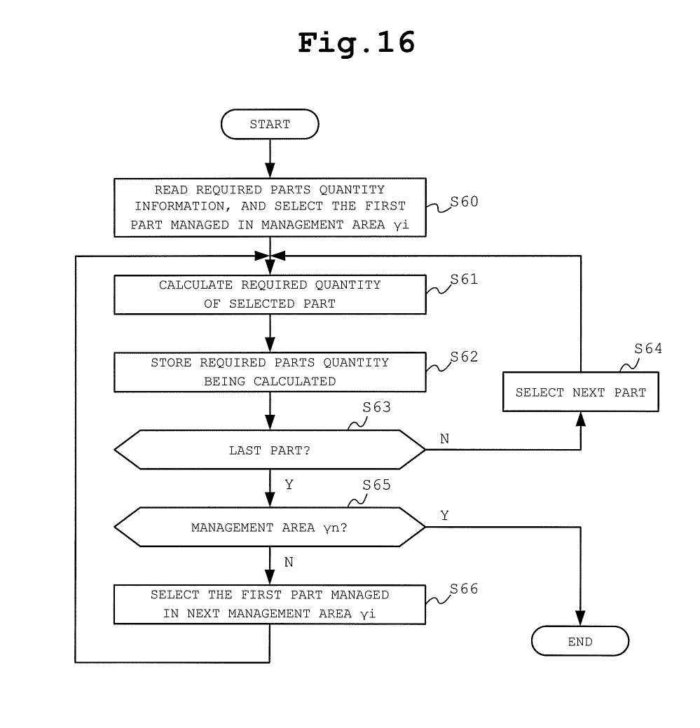

Next, the required parts quantity calculating section 126 performs processing for calculating a required quantity of the parts to be stocked in each management area, according to the quantity of the failure-predicted parts, the quantity of the no-failure-predicted parts, and the failure rates for both quantities, respectively (S13). This process will be explained in detail with reference to FIG. 16.

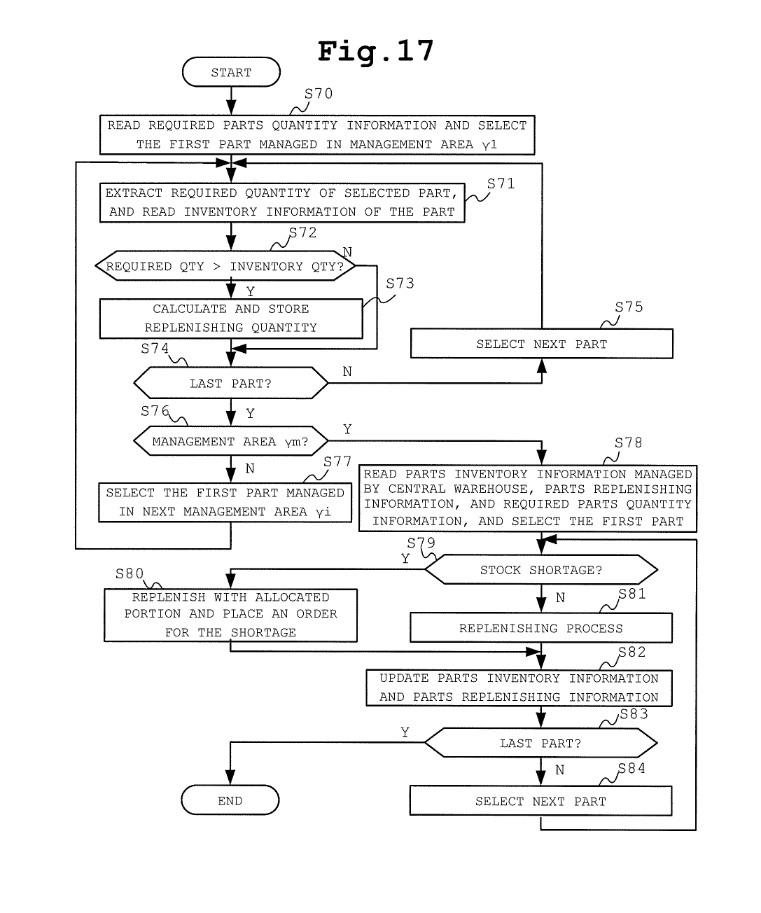

Next, the parts inventory control section 127 performs processing for calculating a quantity of parts to be replenished from the central warehouse to the local warehouse, and an ordered quantity of parts from the central warehouse to the supplier, so that the required parts quantity calculated in step S13 is stocked in the local warehouse (S14). This processing will be explained in detail with reference to FIG. 17.

FIG. 12 is a flowchart showing the process for collecting the sensor information.

Here, in the present embodiment, it is assumed that the sensor information items of the operating equipment 170 identified by the operating equipment numbers α1 to αm, are managed and stored by the operating equipment terminals 180 identified by the operating terminal numbers from β1 to βm, respectively associated with these operating equipment numbers.

Firstly, the sensor information collecting section 123 accesses the operating equipment terminal 180 identified by the first operating equipment terminal number β1, via the communication section 132 (S20).

Next, the sensor information collecting section 123 acquires from the operating equipment terminal 180 being accessed, the sensor information of the operating equipment 170 that is managed by the operating equipment terminal 180 (S21).

Then, the sensor information collecting section 123 stores the sensor information obtained in the step S21, in the sensor information storage area 112, in association with the operating equipment number (S22).

Next, the sensor information collecting section 123 refers to the operating equipment information table 116, determines whether or not the operating equipment 170 as to which the sensor information is obtained in step S22 is the last operating equipment 170 (S23), and if it is not the last operating equipment 170 (“No” in the step S23), the processing proceeds to the step S24, whereas if it is the last operating equipment 170 (“Yes” in step S23), the processing is terminated.

In the step S24, the sensor information collecting section 123 accesses the operating equipment terminal 180 associated with the next operating equipment terminal number βi (“i” is a natural number satisfying 1≦i≦m). Then, the sensor information collecting section 123 returns to the step S21, and repeats the processing.

It is to be noted that the flowchart shown in FIG. 12 illustrates an example to access the operating equipment terminal 180 from the integrated center terminal 110, but another method may be employed to collect the sensor information. By way of example, it is possible to send the sensor information at a predetermined clock time or the like, to the integrated center terminal 110 from the operating equipment terminal 180.

It is further possible that after a process for analyzing the sensor information as shown in FIG. 13 is executed in the operating equipment terminal 180, the operating equipment terminal 180 of the operating equipment 170 determined as abnormal sends the information to the integrated center terminal 110.

FIG. 13 is a flowchart showing the process for analyzing the sensor information.

Firstly, the sensor information analysis section 124 acquires a sensor normal pattern that is stored in the sensor normal pattern information storage area 113 of the storage section 111 (S30).

Next, the sensor information analysis section 124 acquires the sensor information associated with first operating equipment number α1, from the sensor information storage area 112 (S31).

Then, the sensor information analysis section 124 performs abnormality diagnosis based on whether or not a value included in the sensor information acquired in the step S31 is determined as abnormal, with respect to the sensor normal pattern acquired in the step S30 (S32).

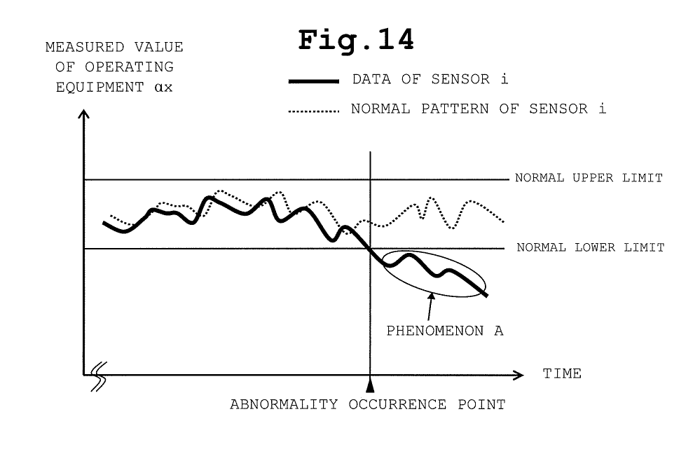

By way of example, in the present embodiment, as shown in FIG. 14 (a schematic diagram for explaining the abnormal diagnostic process), an upper limit and a lower limit are specified to determine normality, in such a manner that the sensor normal pattern is included therebetween, and when a value of the sensor information read in the step S31 does not fall into the range from the upper limit to the lower limit, it is determined as abnormal.

The upper limit and the lower limit may be predetermined in such a manner that the sensor normal pattern is included therebetween. However, for instance, it is possible to calculate the upper limit and the lower limit by adding a predetermined value to or subtracting a predetermined value from a mean value of the sensor normal pattern (within a specific period). It is alternatively possible to calculate the upper limit and the lower limit by adding a predetermined value to or subtracting a predetermined value from a value of the sensor normal pattern.

When it is determined that abnormality is found (“Yes” in step S33), the processing proceeds to the step S34. When it is not determined that abnormality is found (“No” in step S33), the processing proceeds to the step S37.

In the step S34, the sensor information analysis section 124 acquires a failure-predicted pattern stored in the failure-predicted pattern information storage area 114.

The sensor information analysis section 124 specifies out of the failure-predicted patterns acquired in the step S34, one failure-predicted pattern that is the closest to time-series variation of the value within a specific time interval included in the sensor information determined as abnormal, and specifies a record from the failure-predicted pattern table 114a, the record with the failure-predicted pattern number of the specified pattern being stored in the failure-predicted pattern field 114b, thereby specifying a failure-predicted part (S35).

By way of example, in the present embodiment, a difference value is obtained, between the failure-predicted pattern acquired in the step S34 and the time-series variation pattern of the value during a specific time interval (such as an elapsed time from the start of the pattern start) included in the sensor information determined as abnormal, and it is possible to assume that the failure-predicted pattern is the closest, when the sum of absolute values of the difference values being obtained is the smallest. However, the present embodiment is not limited to this example.

Next, the sensor information analysis section 124 stores information stored in the record that is specified in the step S35, in the associated field in the failure prediction information table 115a, and simultaneously stores information for specifying the time when a value of the sensor included in the sensor information determined as abnormal is acquired, in the abnormality occurrence point field 115c, thereby generating a new record in the failure prediction information table 115a (S36).

Then, the sensor information analysis section 124 refers to the operating equipment information table 116, determines whether or not the operating equipment 170 acquiring the sensor information subjected to the abnormality diagnosis in the step S32 is the last operating equipment 170 (S37). If it is not the last operating equipment 170 (“No” in the step S37), the processing proceeds to the step S38, and if it is the last operating equipment 170 (“Yes” in step S37), the processing is terminated.

In the step S38, the sensor information analysis section 124 acquires from the sensor information storage area 112 of the operating equipment 170, which is next to the operating equipment 170 that acquired the sensor information subjected to the abnormality diagnosis in the step S32. Then, the sensor information analysis section 124 returns to the step S32, and repeats the processing.

FIG. 15 is a flowchart showing a categorizing process regarding the operating equipment state.

Firstly, the operating equipment status categorizing section 125 acquires from the operating equipment information storage area 116, the operating equipment information table 116a, and extracts the operating equipment 170 included in the first management area number γ1, from the operating equipment information table 116a (S40).

Next, the operating equipment status categorizing section 125 acquires the failure prediction information table 115a, from the failure prediction information storage area 115, and narrows down records in the failure prediction information table 115a, so as to find a record associated with the extracted operating equipment 170 (S41).

Next, the operating equipment status categorizing section 125 extracts apart number of each of the parts included in the records narrowed down in the step S41 from the failure-predicted part number field 115e, and calculates a quantity of items X of the failure-predicted part according to the part number being extracted (S42). It is to be noted that in the step S42, natural numbers from “1” are allocated to indicate the sequence, to each of the items specified by the extracted part number.

Then, the operating equipment status categorizing section 125 selects the part corresponding to the first item, out of the failure-predicted parts included in the records extracted in the step S42 (S43).

Next, the operating equipment status categorizing section 125 categorizes failure-predicted operating equipment 170 and no-failure-predicted operating equipment 170 (S44).

By way of example, the operating equipment status categorizing section 125 specifies a record including the part number associated with the part being selected, in the failure-predicted part number field 115e of the record extracted in the step S42, and extracts the operating equipment number from the operating equipment number field 115b of the specified record, thereby specifying the failure-predicted operating equipment 170.

Then, the operating equipment status categorizing section 125 specifies a record including the part number associated with the part being selected, in the part number field 116d of the records in the operating equipment information table 116a that is associated with the operating equipment 170 included in the target management area. Then, the no-failure-predicted operating equipment 170 is specified, by excluding the record of the failure-predicted operating equipment 170, from the records of the operating equipment 170 associated with the operating equipment number included in the operating equipment number field 116c of the specified record.

Next, the operating equipment status categorizing section 125 calculates a quantity of the selected parts in the failure-predicted operating equipment 170, categorized in the step S45, and a quantity of the selected parts in the no-failure-predicted operating equipment 170 (S46).

By way of example, the operating equipment status categorizing section 125 specifies a record in the operating equipment information table 116a, where the operating equipment number and the part number of the part being selected are stored in the same record, the operating equipment being either the failure-predicted operating equipment 170 or the no-failure-predicted operating equipment 170, which are categorized in the step S45. Then, the values in the mounted quantity field 116e of the specified record in each of the categorizations are added, thereby calculating the quantity of parts in each of the categorizations.

Next, the operating equipment status categorizing section 125 specifies, a management area number of the management area being an evaluation target, a part number of the part being selected, the quantity of selected part in the failure-predicted operating equipment 170 being calculated in the step S45, the failure rate of the failure-predicted part (specified by the failure rate field 116f of the operating equipment information table 116a), the quantity of part selected in the no-failure-predicted operating equipment 170 calculated in step S45, and a failure rate of the no-failure-predicted part (specified by the failure rate field 116f of the operating equipment information table 116a), and these are respectively stored in the management area field 118b, the part number field 118c, the failure-predicted quantity field 118d, the failure-predicted failure rate field 118e, the no-failure-predicted quantity field 118f, and the no-failure-predicted failure rate field 118g of the required parts quantity information table 118a, (S46). Furthermore, the operating equipment status categorizing section 125 specifies a record in the management information table 117a whose replenishing destination field 117b stores the management area number identifying the area from which the operating equipment is extracted. Then, the operating equipment status categorizing section 125 acquires information items stored respectively in the replenishing source field 117c, the replenishing lead time field 117d, and the failure rate field 117e of the specified record. Then, the acquired information items are stored respectively in the replenishing source field 118i, the replenishing lead time field 118j, and the failure rate field 118k of the required parts quantity information table 118a.

Then, the operating equipment status categorizing section 125 determines whether or not the part item categorized in the step S44 is the last item (S47), and if it is not the last item (“No” in the step S47), the next item is selected in the step S48, and the processing returns to the step S44 and repeats processing. On the other hand, if the item is the last (“Yes” in the step S47), and the processing proceeds to the step S49.

In the step S49, the operating equipment status categorizing section 125 determines whether or not the management area from which the operating equipment 170 is extracted is the last management area. If it is the last management area (“Yes” in the step S49), the processing is terminated, and if it is not the last management area (“No” in the step S49), the processing proceeds to the step S50.

In the step S50, the operating equipment status categorizing section 125 extracts from the operating equipment information table 116a, the operating equipment 170 included in the next management area γi (“i” is a natural number satisfying 1≦i≦n) (S50). Then, the operating equipment status categorizing section 125 returns the procedure to the step S41 and repeats the processing.

FIG. 16 is a flowchart showing the process for calculating the required parts quantity.

Firstly, the required parts quantity calculating section 126 acquires the required parts quantity information table 118a stored in the required parts quantity information storage area 118, and selects the first part (the top record) in the management area associated with the first management area number γ1 (S60).

Next, the required parts quantity calculating section 126 calculates a required quantity of the selected part (S61).

The required parts quantity is calculated, for example, according to the formula of a failure distribution in Poisson distribution as shown (1) in the following.

$$\begin{matrix}[ Formula 1 ] & \\ P ( r ) = \frac{{( λ nt )}^{r} {e}^{- λ nt}}{r !} & ( 1 )\end{matrix}$$

Here, λ represents a failure rate, n represents a sample number, t represents an operation time, r represents a number of failures, and P(r) represents a failure probability.

Specifically in the formula (1), the required parts quantity calculating section 126 inputs in the failure rate λ, the failure-predicted failure rate stored in the failure-predicted failure rate field 118e associated with the selected part, inputs in the sample number n, the number stored in the failure-predicted quantity field 118d associated with the selected part, and inputs in the operation time t, the replenishing lead time in the replenishing lead time field 118j associated with the selected part.

Then, the required parts quantity calculating section 126 obtains an accumulation value by adding a value of P(r) calculated by sequentially substituting positive integers 0, 1, . . . into the failure number r, and obtains the failure number r at the time point when the accumulation value being obtained reaches (1−(probability of stockout)). The value r obtained in this way is assumed as the required quantity when a failure is predicted.

Similarly in the formula (1), the required parts quantity calculating section 126 inputs in the failure rate λ, the failure rate stored in the no-failure-predicted failure rate field 118g associated with the selected part, inputs in the sample number n, the number associated with the selected part and stored in the no-failure-predicted quantity field 118f, and inputs in the operation time t, the replenishing lead time stored in the replenishing lead time field 118j.

Then, the required parts quantity calculating section 126 obtains an accumulation value by adding a value of P(r) calculated by sequentially substituting the numbers 0, 1, . . . into the failure number r, and obtains the failure number r at the time point when the accumulation value being obtained reaches (1−(probability of stockout)). The value r obtained in this way is assumed as the required quantity when no failure is predicted.

Then, the required quantity thus calculated in the case where a failure is predicted, is combined to the required quantity in the case where no failure is predicted, thereby obtaining the required quantity of the part in the local warehouse within the selected management area.

Next, the required parts quantity calculating section 126 stores the required parts quantity calculated in the step S61 in the required quantity field 118h of the required parts quantity information table 118a (S62).

Then, the required parts quantity calculating section 126 determines whether or not the part whose required quantity is calculated in the step S61 is the last part (S63), and if it is not the last part (“No” in step S63), the next part is selected in the step S64, and after returning to the step S61, the processing is repeated. On the other hand, if it is the last part (“Yes” in the step S63), the processing proceeds to the step S65.

In the step S65, the required parts quantity calculating section 126 determines whether or not the required parts quantity managed in the management area associated with the last management area number γ is calculated, and if it is the last management area (“Yes” in step S65), the processing is terminated. If it is not the last management area (“No” in the step S65) the procedure proceeds to the step S66.

In the step S66, the required parts quantity calculating section 126 selects the first part (the top record) of the parts managed in the management area associated with the next management area number γi, and after returning to the step S61, the processing is repeated.

FIG. 17 is a flowchart showing the processing for controlling the parts inventory.

Firstly, the parts inventory control section 127 acquires the required parts quantity information table 118a stored in the required parts quantity information storage area 118, and selects the first part (the top record) of the parts managed in the management area associated with the first management area number γ1 (S70).

Next, the parts inventory control section 127 extracts the required parts quantity of the part being selected, from the required quantity field 118h of the required parts quantity information table 118a, and acquires a parts inventory quantity of the selected part in the management area being a target, from the available inventory quantity field 119d of the parts inventory information table 119a (S71).

Next, the parts inventory control section 127 determines whether or not the required parts quantity of the part being selected goes over the parts inventory quantity (S72), and if it is more than the parts inventory quantity (“Yes” in the step S72), the processing proceeds to the step S73, and if it is not more than the parts inventory quantity (“No” in the step S72), the processing proceeds to the step S74.

In the step S73, the parts inventory control section 127 subtracts from the required quantity of the part being selected, the parts inventory quantity, calculates a replenishing quantity of the part, and stores the replenishing quantity in the replenishing quantity field 120e of the parts replenishing information table 120a (S73). In the record where the replenishing quantity is stored, the parts inventory control section 127 stores in the replenishing destination field 120b, the management area number of the management area being the target, stores the part number of the selected part in the part number field 120c, and stores the information for specifying the central warehouse in the replenishing source field 120d.

In the step S74, the parts inventory control section 127 determines whether or not the selected part is the last part managed in the management area being a target. If it is not the last part (“No” in the step S74), the next part is selected in the step S75 and the procedure returns to the step S71 to repeat the processing. On the other hand, if it is the last part (“Yes” in the step S74), the processing proceeds to the step S76.

In the step S76, the parts inventory control section 127 determines whether or not the management area that manages the part as to which the replenishing quantity is calculated is the last management area. If it is not the last management area (“No” in the step S76), the processing proceeds to the step S77, and if it is the last management area (“Yes” in the step S76), the processing proceeds to the step S78.

In the step S77, the parts inventory control section 127 selects the first part (the top record) managed in the management area associated with the next management area number γi, in the required parts quantity information table 118a. Then, the procedure returns to the step S71 to repeat the processing.

On the other hand, in the step S78, the parts inventory control section 127 acquires from the storage section 111, the parts inventory information table 119a, the parts replenishing information table 120a, and the required parts quantity information table 118a, which are associated with the central warehouse, and selects the first part stored in the parts replenishing information table 120a.

Next, the parts inventory control section 127 determines whether or not the replenishing quantity of the selected part goes over the inventory quantity of the central warehouse (specified by the available inventory quantity field 119d of the parts inventory information table 119a of the central warehouse) (S79). Then, the parts inventory control section 127 proceeds the processing to the step S80, when the replenishing quantity of the selected part goes over the inventory quantity of the central warehouse (“Yes” in the step S79), and if it is not more than the inventory quantity (“No” in the step S79), the processing proceeds to the step S81.

In the step S80, when the replenishing quantity of the selected part exceeds the inventory quantity of the central warehouse, the parts inventory control section 127 calculates the exceeding quantity as a shortage of the selected part, generates an ordering data in a format including the shortage and the information for specifying the selected part, and carries out processing for sending the ordering data to the supplier terminal 140 via the communication section 132.

On the other hand, in the step S81, the parts inventory control section 127 outputs to the output section 131, an instruction to replenish the replenishing quantity of the selected part from the central warehouse to the local warehouse in the management area being a target.

Then, the parts inventory control section 127 reflects the processing result in the step S80 or in the step S81 to the parts inventory information table 119a associated with the central warehouse, and the parts replenishing information table 120a (S82).

Specifically, when the processing in the step S80 is carried out, the parts inventory control section 127 transfers the inventory quantity stored in the available inventory quantity field 119d of the parts inventory information table 119a to the allocated inventory quantity field 119e, sets the inventory quantity of the central warehouse as the value of the replenishing quantity field 120e of the record in the parts replenishing information table 120a associated with the selected part, calculates a date obtained by adding to the date when the processing is performed, the lead time specified in the replenishing lead time field 118j of the required parts quantity information table 118a, and stores the calculated date in the receiving date field 120f. Even more particularly, the parts inventory control section 127 stores a character string “WILL BE IN STOCK” in the status field 120g of the record.

Furthermore, the parts inventory control section 127 adds a new record similar to the record of the parts replenishing information table 120a associated with the selected part, changes the value of the replenishing quantity field 120e of the added record to the quantity ordered to the supplier, calculates a date and stores the date in the receiving date field 120f, the calculated date being obtained by adding to the date when the processing is performed, the lead time from the central warehouse to the local warehouse (specified by the replenishing lead time field 118j of the required parts quantity information table 118a) and the lead time (being preset) from the supplier to the central warehouse. In addition, the parts inventory control section 127 stores a character string “WILL BE IN STOCK” in the status field 120g of the record.

On the other hand, if the processing in the step S81 is carried out, the parts inventory control section 127 subtracts the replenishing quantity of the selected part, from the inventory stored in the available inventory quantity field 119d of the parts inventory information table 119a, and stores the subtracted quantity in the allocated inventory quantity field 119e.

Next, the parts inventory control section 127 determines whether or not the selected part is the last part (S83), and if it is not the last part (“No” in the step S83), the next part is selected in the step S84, and after returning to the step S79, the processing is repeated. On the other hand, if it is the last part (“Yes” in the step S83), the processing is terminated.

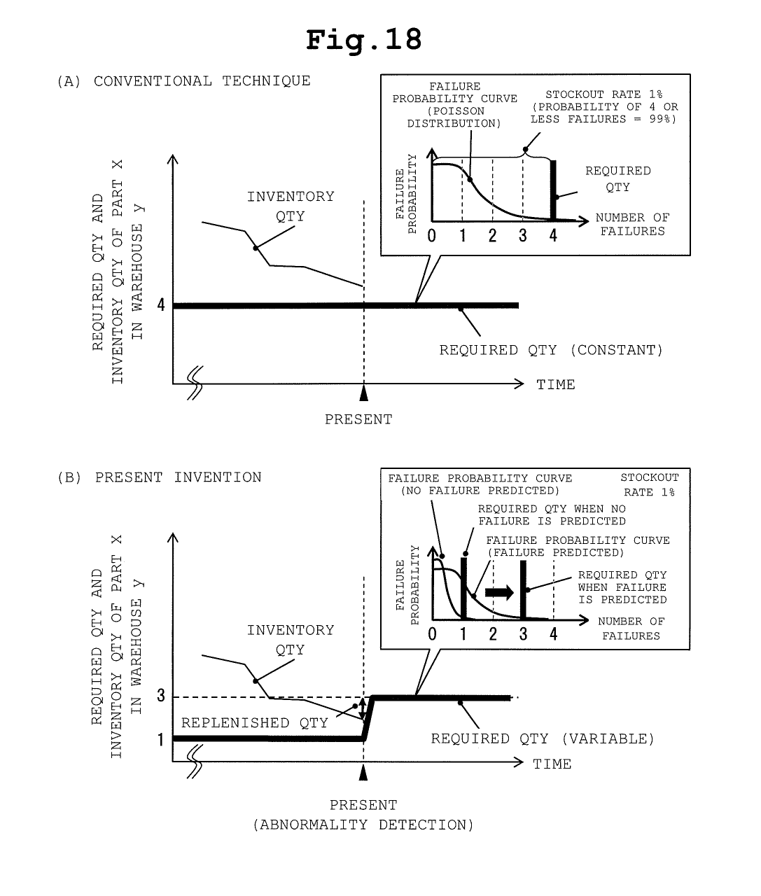

As discussed above, for example, as shown in FIG. 18 (a schematic diagram showing the inventory quantity of the local warehouse in the parts inventory control system 100), conventionally, a certain amount of parts determined as necessary has to be managed (FIG. 18A). However, according to the present invention, if a failure is predicted, it is only required to increase the inventory quantity of the local warehouse which manages the part (FIG. 18B), thereby enabling reduction of inventory load in the local warehouse.

In the embodiment discussed above, if the inventory quantity of a specific local warehouse is not able to satisfy the required parts quantity, parts are replenished from the central warehouse, but this is not the only example. Other local warehouse may replenish the parts.

On the other hand, if the inventory quantity of the central local warehouse is not able to satisfy the required parts quantity, an order is placed with a supplier for the part, but this is not the only example. Parts may be procured from other local warehouse.

In the embodiment as described above, processing is performed by the integrated center terminal 110. However, this is not the only example. It is possible to configure such that at least one of the supplier terminal 140, the central warehouse terminal 150, the local warehouse terminal 160, and the operating equipment 170 and the operating equipment terminal 180, may be allowed to perform the same processing as performed by the integrated terminal 110, thereby allowing at least one of those terminals to perform the processing that is performed by the integrated center terminal 110.

### DENOTATION OF REFERENCE NUMERALS

100 PARTS INVENTORY CONTROL SYSTEM
110 INTEGRATED CENTER TERMINAL
111 STORAGE SECTION
112 SENSOR INFORMATION STORAGE AREA
113 SENSOR NORMAL PATTERN INFORMATION STORAGE AREA
114 FAILURE-PREDICTED PATTERN INFORMATION STORAGE AREA
115 FAILURE-PREDICTED INFORMATION STORAGE AREA
116 OPERATING EQUIPMENT INFORMATION STORAGE AREA
117 MANAGEMENT INFORMATION STORAGE AREA
118 REQUIRED PARTS QUANTITY INFORMATION STORAGE AREA
119 PARTS INVENTORY INFORMATION STORAGE AREA
120 PARTS REPLENISHING INFORMATION STORAGE AREA
122 CONTROL SECTION
123 SENSOR INFORMATION COLLECTING SECTION
124 SENSOR INFORMATION ANALYSIS SECTION
125 OPERATING EQUIPMENT STATUS CATEGORIZING SECTION
126 REQUIRED PARTS QUANTITY CALCULATING SECTION
127 PARTS INVENTORY CONTROL SECTION
128 INFORMATION UPDATE SECTION
130 INPUT SECTION
131 OUTPUT SECTION
132 COMMUNICATION SECTION
140 SUPPLIER TERMINAL
150 CENTRAL WAREHOUSE TERMINAL
160 LOCAL WAREHOUSE TERMINAL
170 OPERATING EQUIPMENT
180 OPERATING EQUIPMENT TERMINAL

What is claimed is:

1. A terminal for managing parts inventory prepared for more than one unit of operating equipment, the terminal comprising a storage section and a control section;
the storage section storing failure-predicted pattern information including information for specifying;
a failure-predicted pattern which is a pattern of a value obtained from a sensor monitoring a state of the operating equipment and indicates that a failure is predicted as to a part used in the operating equipment, the part having a possibility of failure occurrence when the failure-predicted pattern appears, and a first failure rate indicating a probability that the part fails to operate properly when the failure is predicted, and
the storage section further storing operating equipment information including information for specifying; the operating equipment, the part used in the operating equipment, a quantity of the part used in the operating equipment, and a second failure rate indicating the probability that the part fails to operate properly when no failure is predicted, wherein,
the control section performs;
a process for specifying from the failure-predicted pattern information, a failure-predicted pattern which is associated with a pattern of the value, being determined as abnormal when obtained from the sensor which monitors the state of the operating equipment,
a process for specifying the part having a possibility of malfunction as a failure-predicted part according to the failure-predicted pattern being specified,
a process for specifying as a failure-predicted quantity from the operating equipment information, being a quantity of the failure-predicted part used in the operating equipment that has the value obtained from the sensor being determined as abnormal,
a process for specifying as a no-failure-predicted quantity from the operating equipment information, being the quantity of the part of the same sort as the failure-predicted part, used in operating equipment other than the operating equipment that has the value obtained from the sensor being determined as abnormal, among at least one unit of the operating equipment,
a process for calculating a first required quantity that is required as an inventory, when the part corresponding to the failure-predicted quantity fails to operate properly at the first failure rate,
a process for calculating a second required quantity that is required as the inventory, when the part corresponding to the no-failure-predicted quantity fails to operate properly at the second failure rate, and
a process for calculating a required inventory quantity of the part that is of the same sort as the failure-predicted part, by adding the first required quantity and the second required quantity.

2. The terminal according to claim 1, wherein,
the control section calculates the first required quantity according to a Poisson distribution, in such a manner that the first required quantity becomes equal to or less than a quantity according to a predetermined stockout probability, the first required quantity corresponding to a quantity which becomes necessary as the inventory, when the failure-predicted quantity of the part fails to operate properly at the first failure rate with a lead time of the part.

3. The terminal according to claim 1, wherein,
the control section calculates the second required quantity according to a Poisson distribution, in such a manner that the second required quantity becomes equal to or less than a quantity according to a predetermined stockout probability, the second required quantity corresponding to a quantity which becomes necessary as the inventory, when the no-failure-predicted quantity of the part fails to operate properly at the second failure rate with a lead time of the part.

4. The terminal according to claim 1, wherein,
the storage section stores, with respect to each operating equipment, parts inventory information for specifying a predetermined area which includes the operating equipment, the part used in the operating equipment, and an inventory quantity of the part in a warehouse assigned in the area, and
the control section performs,
a process for specifying from the parts inventory information, the inventory quantity of the part which is of the same sort as the failure-predicted part of the operating equipment which obtains from the sensor the value determined as abnormal,
a process for specifying as a replenishing quantity, a value obtained by subtracting the inventory quantity from the required inventory quantity, when the required inventory quantity is larger than the inventory quantity being specified, and
a process for outputting to the output section, an instruction for replenishing the replenishing quantity, from a warehouse other than the warehouse assigned to the predetermined area including the operating equipment which obtains from the sensor the value determined as abnormal.

5. The terminal according to claim 4, wherein,
the control section performs a process for placing an order for a shortage that is obtained by subtracting the inventory quantity of the other warehouse from the replenishing quantity, when the replenishing quantity is larger than the inventory quantity of the warehouse other than the warehouse assigned to the predetermined area including the operating equipment that obtains from the sensor the value determined as abnormal.

6. A program which allows a computer to function as a terminal for managing parts inventory prepared for more than one unit of operating equipment, the program allowing the computer to function as a storage means and a control means;
the storage means storing failure-predicted pattern information including information for specifying;
a failure-predicted pattern which is a pattern of a value obtained from a sensor monitoring a state of the operating equipment and indicates that a failure is predicted as to a part used in the operating equipment, the part having a possibility of failure occurrence when the failure-predicted pattern appears, and a first failure rate indicating a probability that the part fails to operate properly when the failure is predicted, and
the storage means further storing operating equipment information including information for specifying; the operating equipment, the part used in the operating equipment, a quantity of the part used in the operating equipment, and a second failure rate indicating the probability that the part fails to operate properly when no failure is predicted, wherein,
the program allowing the control means to perform;
a process for specifying from the failure-predicted pattern information, a failure-predicted pattern which is associated with a pattern of the value, being determined as abnormal when obtained from the sensor which monitors the state of the operating equipment,
a process for specifying the part having a possibility of malfunction as a failure-predicted part according to the failure-predicted pattern being specified,
a process for specifying as a failure-predicted quantity from the operating equipment information, being a quantity of the failure-predicted part used in the operating equipment that has the value obtained from the sensor being determined as abnormal,
a process for specifying as a no-failure-predicted quantity from the operating equipment information, being the quantity of the part of the same sort as the failure-predicted part, used in operating equipment other than the operating equipment that has the value obtained from the sensor being determined as abnormal, among at least one unit of the operating equipment,
a process for calculating a first required quantity that is required as an inventory, when the part corresponding to the failure-predicted quantity fails to operate properly at the first failure rate,
a process for calculating a second required quantity that is required as the inventory, when the part corresponding to the no-failure-predicted quantity fails to operate properly at the second failure rate, and
a process for calculating a required inventory quantity of the part that is of the same sort as the failure-predicted part, by adding the first required quantity and the second required quantity.

7. The program according to claim 6, allowing the control means to calculate the first required quantity according to a Poisson distribution, in such a manner that the first required quantity becomes equal to or less than a quantity according to a predetermined stockout probability, the first required quantity corresponding to a quantity which becomes necessary as the inventory, when the failure-predicted quantity of the part fails to operate properly at the first failure rate with a lead time of the part.

8. The program according to claim 6, allowing the control means to calculate the second required quantity according to a Poisson distribution, in such a manner that the second required quantity becomes equal to or less than a quantity according to a predetermined stockout probability, the second required quantity corresponding to a quantity which becomes necessary as the inventory, when the no-failure-predicted quantity of the part fails to operate properly at the second failure rate with a lead time of the part.

9. The program according to claim 6,
allowing the storage means to store, with respect to each operating equipment, parts inventory information for specifying a predetermined area which includes the operating equipment, the part used in the operating equipment, and an inventory quantity of the part in a warehouse assigned in the area, and
allowing the control means to perform,
a process for specifying from the parts inventory information, the inventory quantity of the part which is of the same sort as the failure-predicted part of the operating equipment which obtains from the sensor the value determined as abnormal,
a process for specifying as a replenishing quantity, a value obtained by subtracting the inventory quantity from the required inventory quantity, when the required inventory quantity is larger than the inventory quantity being specified, and
a process for outputting to the output section, an instruction for replenishing the replenishing quantity, from a warehouse other than the warehouse assigned to the predetermined area including the operating equipment which obtains from the sensor the value determined as abnormal.

10. The program according to claim 9, allowing the control means to perform a process for placing an order for a shortage that is obtained by subtracting the inventory quantity of the other warehouse from the replenishing quantity, when the replenishing quantity is larger than the inventory quantity of the warehouse other than the warehouse assigned to the predetermined area including the operating equipment that obtains from the sensor the value determined as abnormal.

11. An inventory management method in which a terminal manages parts inventory prepared for more than one unit of operating equipment, the terminal comprising a storage section and a control section;
the storage section storing failure-predicted pattern information including information for specifying; a failure-predicted pattern which is a pattern of a value obtained from a sensor monitoring a state of the operating equipment and indicates that a failure is predicted as to a part used in the operating equipment, the part having a possibility of failure occurrence when the failure-predicted pattern appears, and a first failure rate indicating a probability that the part fails to operate properly when the failure is predicted, and
the storage section further storing operating equipment information including information for specifying; the operating equipment, the part used in the operating equipment, a quantity of the part used in the operating equipment, and a second failure rate indicating the probability that the part fails to operate properly when no failure is predicted, wherein,
the control section comprising the steps of;
specifying from the failure-predicted pattern information, a failure-predicted pattern which is associated with a pattern of the value being determined as abnormal when obtained from the sensor which monitors the state of the operating equipment,
specifying the part having a possibility of malfunction as a failure-predicted part according to the failure-predicted pattern being specified,
specifying as a failure-predicted quantity from the operating equipment information, being a quantity of the failure-predicted part used in the operating equipment that has the value obtained from the sensor being determined as abnormal,
specifying as a no-failure-predicted quantity from the operating equipment information, being the quantity of the part of the same sort as the failure-predicted part, used in operating equipment other than the operating equipment that has the value obtained from the sensor being determined as abnormal, among at least one unit of the operating equipment,
calculating a first required quantity that is required as an inventory, when the part corresponding to the failure-predicted quantity fails to operate properly at the first failure rate,
calculating a second required quantity that is required as the inventory, when the part corresponding to the no-failure-predicted quantity fails to operate properly at the second failure rate, and
calculating a required inventory quantity of the part that is of the same sort as the failure-predicted part, by adding the first required quantity and the second required quantity.
